(19) United States
(12) Patent Application Publication
(10) Pub. No.: US 2019/0205843 A1
(43) Pub. Date: Jul. 4, 2019

(54) SYSTEM AND PROCESS FOR MAINTENANCE MANAGEMENT DURING A MASS GATHERING

(71) Applicant: BULL SAS, Les Clayes-sous-Bois (FR)

(72) Inventors: Samia Benrachi, Chatenay-Malabry (FR); Taoufik Mohib, Riyadh - KSA (SA); Emmanuel Wensink, Bern (CH)

(21) Appl. No.: 16/233,702

(22) Filed: Dec. 27, 2018

(30) Foreign Application Priority Data
Dec. 31, 2017 (FR) 1763429

(51) Int. Cl. G06Q 10/00; H04W 4/021; H04W 4/18; H04W 4/33; G06N 20/00

(52) U.S. Cl. CPC G06Q 10/20; H04W 4/021; G06N 20/00; H04W 4/33; H04W 4/185

(57) ABSTRACT

The invention relates to a dynamic management system (1) of the maintenance of a geographic location during a mass gathering, said geographic location comprising a plurality of installations, said system being capable of communicating with a plurality of maintenance resources (30) involved in the maintenance of the geographic location, and said system comprising an analytical platform (100) comprising:
an acquisition module (110) of distribution data able to record a distribution datum of participants at said gathering,
a calculation module (120) of needs able to determine the installations requiring maintenance action from the distribution datum,
a distribution module (130) of resources configured to set up associations between the maintenance resources (30) and the installations requiring maintenance action so as to manage the maintenance of the geographic location during said mass gathering, and
an analysis module (190) configured to generate analysed data from said associations so as to allow dynamic management of maintenance of the geographic location.

The invention relates to the field of management of mass gatherings, and more particularly a system for maintenance management which can be used in terms of a mass gathering so as to organize the upkeep of clean and functional premises despite the multitude of participants at the gathering. The invention also relates to a process for maintenance management during a mass gathering capable especially of optimizing the use of available resources, and this dynamically according to the usage of said gathering.

### PRIOR ART

Large gatherings, also called mass events or mass gatherings, are characterized by a large number of people attending or participating in a public event, for example a pilgrimage, a sports competition or a concert. With the rise in population, communication and democratisation of transport over long distances, these large gatherings are more and more frequent and involve increasingly larger and more disparate numbers of people.

Events likely to attract the largest number of people are often pilgrimages such as the Hajj which is the biggest annual populational gathering worldwide, the Kumbh Mela which is the biggest gathering of Hindus worldwide or even papal masses, often several attracting millions of people. For 2011, the central department for statistics and information of the Kingdom of Saudi Arabia identified close to 3 million pilgrims for the Hajj. Despite controls exerted by Hajj authorities, the number of pilgrims over the period of a few days of Hajj exceeds 2.5 million each year. It is increasingly probable that this number will reach 10 million visitors per year in a few years. Apart from pilgrimages, those events likely to assemble a resulting crowd are for example sports events (e.g. World Cup) or cultural events (e.g. Universal Exhibition). For example, for the Olympic Games of 2024 in France, the number of spectators expected on average during the fortnight of the games is estimated at over three million including 500,000 overseas visitors.

The presence of a large number of people participating in mass gatherings generally causes wear on installations with occasional damage which has to be repaired without affecting the procedure of the gathering or quite simply consumption of products made available which need to be replenished. The causes of these nuisances or damage can be highly diverse but are often linked to the number of participants. To compensated best here, it is necessary to distribute proper resources (human or material) fast and at an adequate level.

Therefore, administrations in charge of maintenance of a site associated with a large gathering are confronted with a difficult task, since poor administration of their resources can bring extra costs and nuisances unacceptable for participants at the mass gathering. In particular, maintenance has become a strategic subject during the grand pilgrimage to Mecca (Hajj), with a growing number of pilgrims.

In general, techniques most used for management of maintenance are techniques associated with the coping with daily planning which staff must respect. Yet such management is not adapted to all gatherings and some gatherings, especially mass gatherings, need dynamic maintenance management for optimizing distribution of resources and retaining a high level of comfort for participants. Therefore, there is a difficulty in effectively managing the available resources for maintenance of a site receiving a mass gathering.

There is therefore a need for a process or a system for improving maintenance management during a large gathering and especially for use of resources while retaining the prerogatives relative to the hygiene and safety procedures and therefore a high level of comfort for participants. Apart from these considerations it is also necessary to provide a process or a system capable of managing said maintenance dynamically and as a function of the use of infrastructures of the gathering venue.

### TECHNICAL PROBLEM

The aim of the invention therefore is to rectify the disadvantages of the prior art. In particular, the aim of the invention is to propose a system of maintenance management in terms of a mass gathering, said system determining what maintenance to apply at which time and on which installation and to do this fast and automated.

Another aim of the invention is to propose a process for maintenance management in terms of a mass gathering, bringing together at least several thousand people, at a gathering site, said process which can be used to identify maintenance actions to be taken, classify them by order of priority and allocate the necessary resources.

### BRIEF DESCRIPTION OF THE INVENTION

For this purpose, the invention relates to a system for dynamic maintenance management of a geographic location during a mass gathering, said geographic location comprising a plurality of installations, said system being capable of communicating with a plurality of maintenance resources involved in the maintenance of the geographic location, said system comprising an analytical platform comprising:
an acquisition module of distribution data able to record a distribution datum of participants at said gathering,
a calculation module of needs able to determine the installations requiring maintenance action from the distribution datum,
a distribution module of resources configured to set up associations between the maintenance resources and the installations requiring maintenance action so as to manage the maintenance of the geographic location during said mass gathering, and
an analysis module configured to generate analysed data from said associations so as to allow dynamic maintenance management of the geographic location.

Therefore, the invention relates to a system of maintenance management of a geographic location during a mass gathering having the advantage of being able to manage dynamically (e.g. as a function of perceived real needs) and effectively distribution of maintenance resources from data which can be acquired automatically, such as a distribution datum of participants. Such a system optimizes maintenance resources so as to give participants a high quality experience and also avoid wasting maintenance resources.

Such a system is particularly useful in terms of maintenance management during mass gatherings such as the small and the grand pilgrimage to Mecca to keep the venue clean and functional despite the multitude of participants at the gathering.

According to other optional characteristics of the system:
the acquisition module of distribution data is further able to calculate the distribution datum from first distribution data of participants generated from data from image acquisition devices and data from network sensors.
the calculation module of needs is configured to use complementary data to determine installations requiring maintenance action so as to produce a more precise result on those installations requiring maintenance action. The complementary data are advantageously selected from: measurement data of the state of the installation generated by one or more sensors positioned in the installation and configured to measure the state of the installation, data relative to former maintenance actions stored on a recording module, data of intervention thresholds recorded in a repository and/or data relative to the mass gathering recorded in a repository.
the sensor or sensors are selected from: a backup device of consumption, a backup device of wear on installations, a backup device of cleanliness of installations, a backup device of geographic position and a backup device of incidents.
the calculation module of needs is further configured to receive information on the state of installations originating from one or more sensors positioned in each of one or more installations, receive the distribution datum of participants at said gathering, and determine the installations requiring maintenance action from information on the state of installations and of the distribution datum of people.
the calculation module of needs is further configured to generate a list comprising the state of each of the installations. The calculation module of needs can also determine a schedule at which each of the installations will have exceeded a predetermined intervention threshold. Such a capacity provides maintenance actions over time to prevent any occurrence of a nuisance for participants at the mass gathering.
the analytical platform further comprises a management module of resources configured to generate an item of information, preferably in real time, on the distribution of maintenance resources. The possibility offered by the invention to carry out this generation in real time, that is, for example in under one hour, preferably under thirty minutes, reinforces the dynamic and adaptative aspect of the system according to the invention. The management module of resources can further generate information on the competence of maintenance technicians and/or maintenance actions which have already been attributed to them.
the management module of resources is further configured to identify a period of prolonged inactivity of a maintenance resource. Such a capacity lets the system optimize the use of maintenance resources and can also be used to prevent any fraudulent actions of said resources.
the management module of resources is further configured to calculate, in real time, a surcharge rate for maintenance resources on a part of the geographic location, said management module of resources being configured to:
   Receive a datum on the distribution of participants at said mass gathering on said part of the geographic location,
   Receive a datum on the distribution of maintenance resources on said part of the geographic location,
   Receive a datum on the reception capacity of said part of the geographic location, and
   Calculate a surcharge rate for maintenance resources from distribution data of participants, distribution of maintenance resources and the reception capacity.

Therefore, the surcharge rate is calculated dynamically according to usage of said site. Calculation of a surcharge rate will inter alia construct statistical data on these occasional events and therefore be able to take preventive steps. Also, following calculation of the surcharge rate for maintenance resources, the system according to the invention can control opening of partitions and/or sending an alert message aimed at preventing crowd movement.
the management module of resources is configured to receive a datum relative to the risk of exceeding the capacity of a zone, receive a datum on the distribution of maintenance resources especially in said zone, and send an alert message to the personal devices of maintenance technicians present in said zone. Here too, the system according to the invention can control opening of partitions and/or sending an alert message aimed at preventing crowd movement.
the analytical platform is capable of communicating with a portable maintenance device comprising a display device, said portable device being configured so as to display at least one item of information on the installations requiring maintenance action and/or a path from the current position to an installation requiring maintenance action.
the analytical platform further comprises a recording module able to record the data received and/or generated by the platform and able to manage a historical record of said data.
the analytical platform further comprises a learning module able to execute a supervised or non-supervised learning model so as to generate predictive data selected from: predicted data on distribution of participants at said gathering, predicted data of the state of installations, predicted data of needs of maintenance actions (that is, installations requiring maintenance action), predicted data of position of maintenance resources and predicted data of consumption of resources.
The analysis module is configured to generate, from historical data, analysed data selected from the following analysed data:
   List of the most frequent maintenance actions or using the most energy in terms of maintenance resources,
   List of installations using the most energy in terms of maintenance resources,
   Real or predicted distribution of participants at said gathering as a function of time,
   Real or predicted needs of maintenance actions as a function of time,
   Real or predicted position of maintenance resources as a function of time, and
   Real or predicted consumption of resources.

Advantageously, these data can then be processed by representation applications so as to highlight pertinent information (format of “heat maps” type). Therefore, the analysis module can generate statistical data to optimize maintenance actions. It also reduces wasting of resources. These analysed data can also be recorded in the form of files on a memory.
the analytical platform further comprises a supervision module, comprising a display device, allowing real-time supervision of maintenance resources and configured to display at least one item of information on the installations requiring maintenance action, those installations which are receiving maintenance, those installations which have been maintained and/or a list of maintenance available resources.

The invention also relates to a management process of the maintenance of a geographic location, comprising a plurality of installations, by a plurality of maintenance resources during a mass gathering, said process comprising in particular the following steps:
recording, by an acquisition module of distribution data, of a distribution datum of participants at said gathering,
determination, by a calculation module of needs, of installations requiring maintenance action as a function of the distribution datum of participants at said gathering, and
setting up, by a distribution module of resources, of associations between maintenance resources and the installations requiring maintenance action.

Other advantages and characteristics of the invention will emerge from the following description given by way of illustrative and non-limiting example in reference to the appended figures, in which:

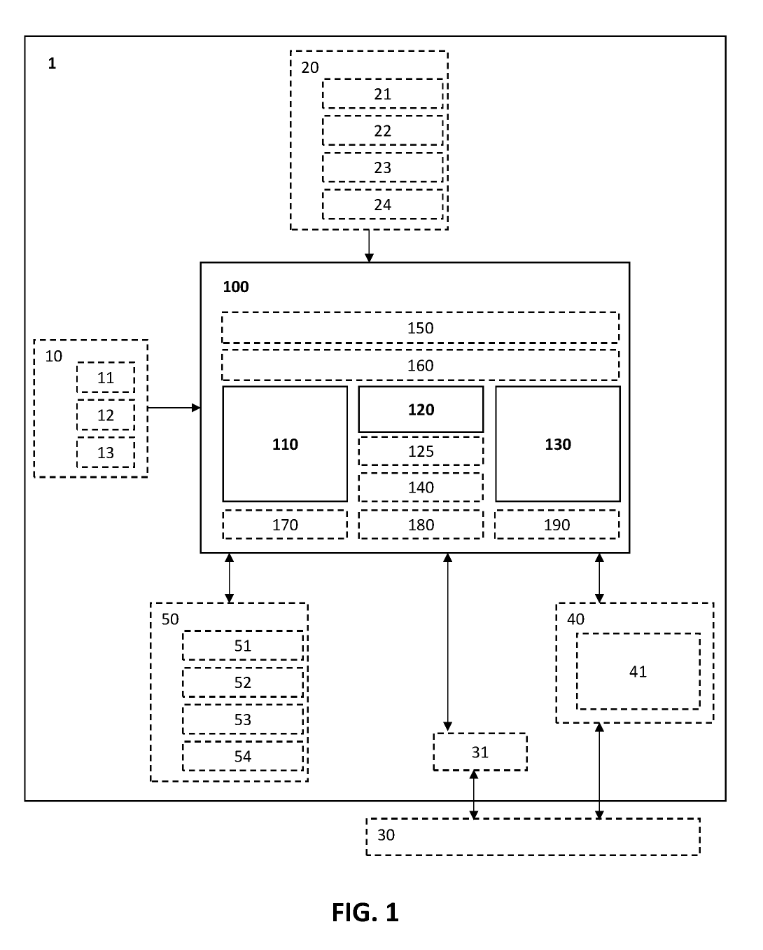

FIG. 1 a schematically illustrates the system of maintenance management according to the invention, the elements in dotted lines being optional.

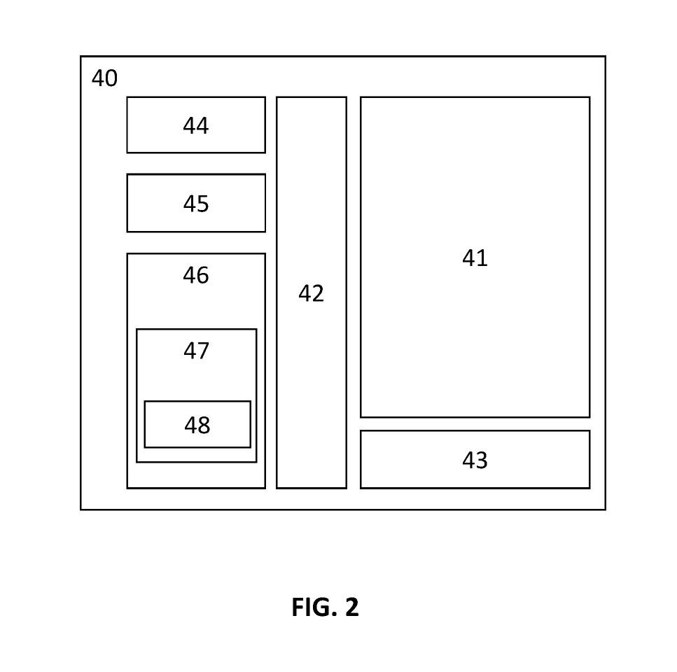

FIG. 2 schematically illustrates a portable maintenance management device according to the invention,

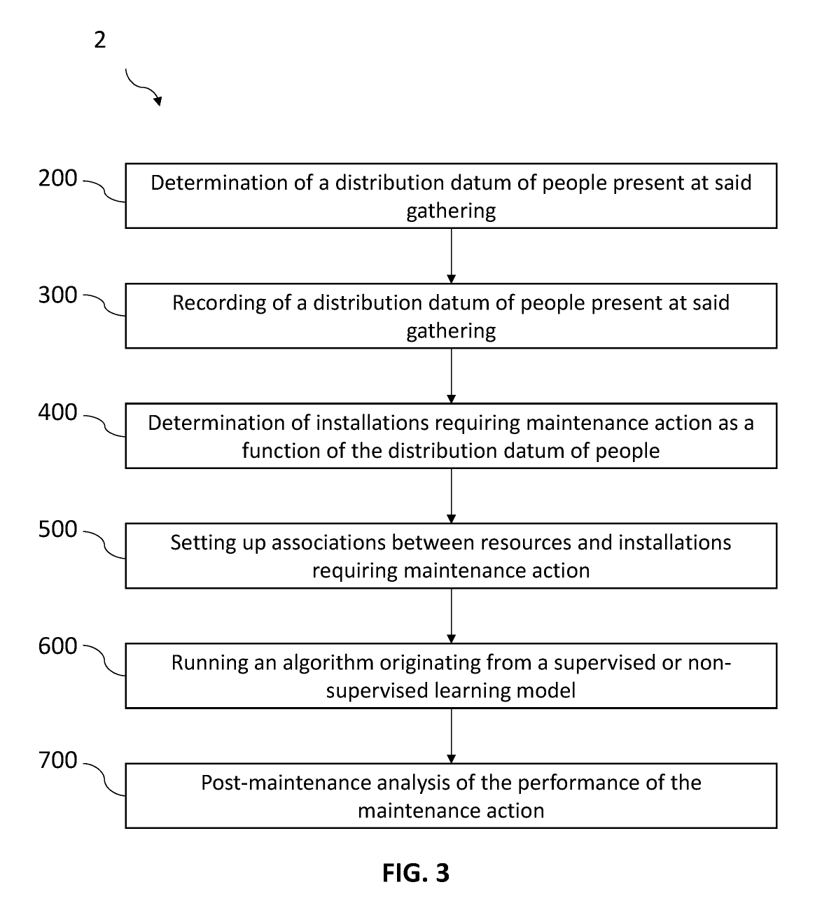

FIG. 3 illustrates the maintenance management process according to the invention,

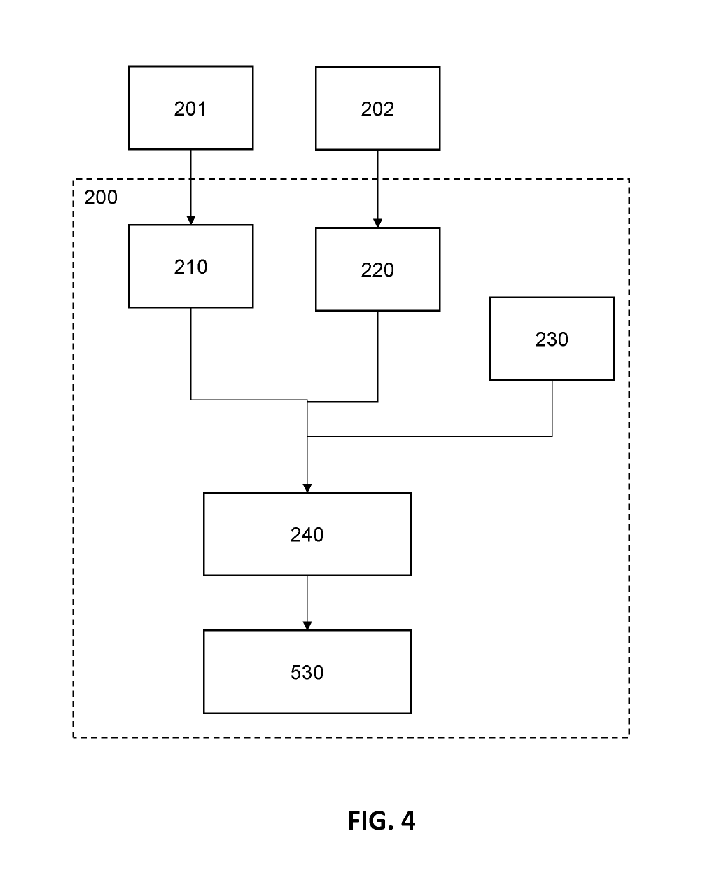

FIG. 4 illustrates a process of acquisition of the distribution datum of participants at said gathering,

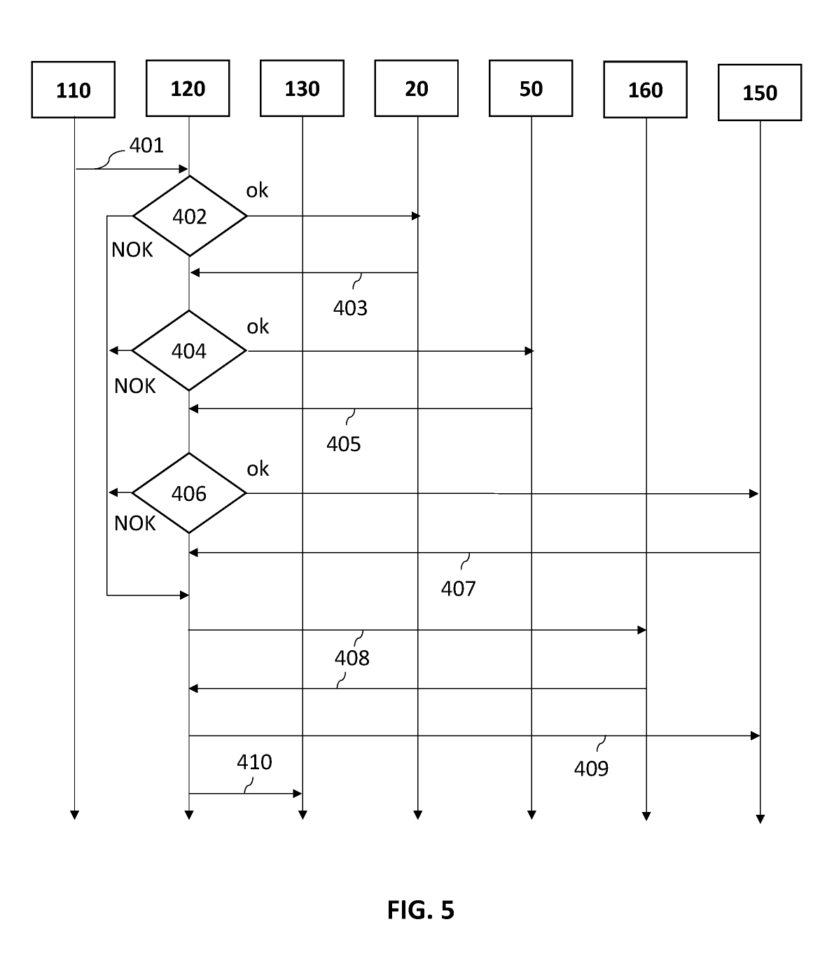

FIG. 5 illustrates a step for determination of installations requiring maintenance action according to the invention,

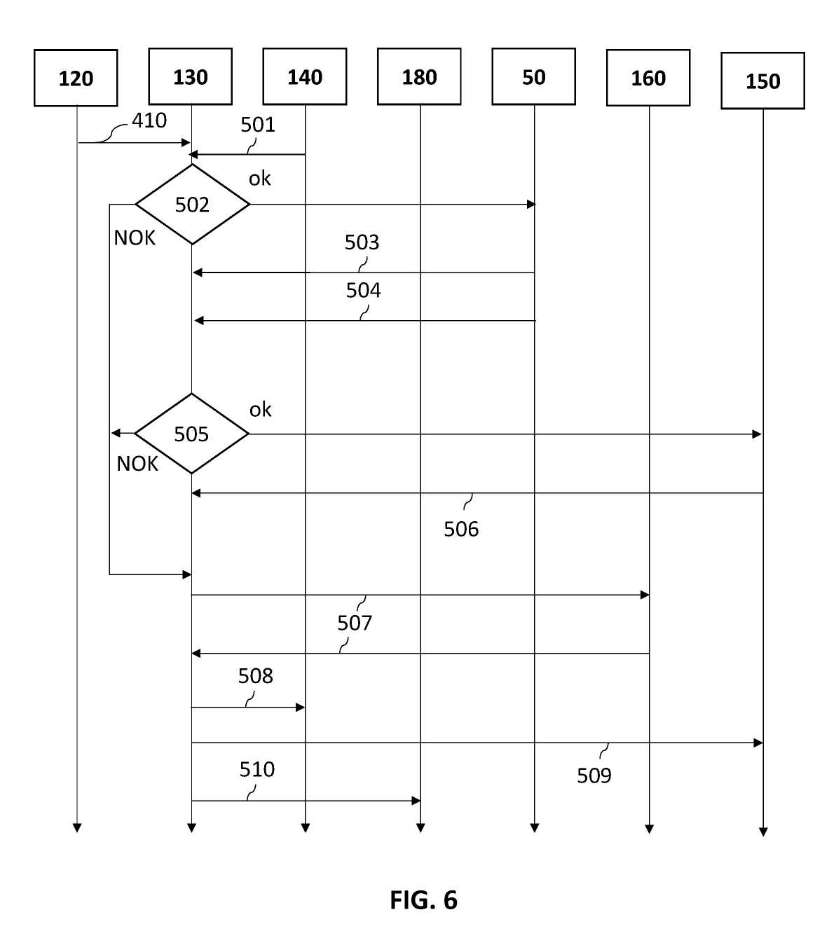

FIG. 6 illustrates a step for setting up associations between resources and installations requiring maintenance action according to the invention,

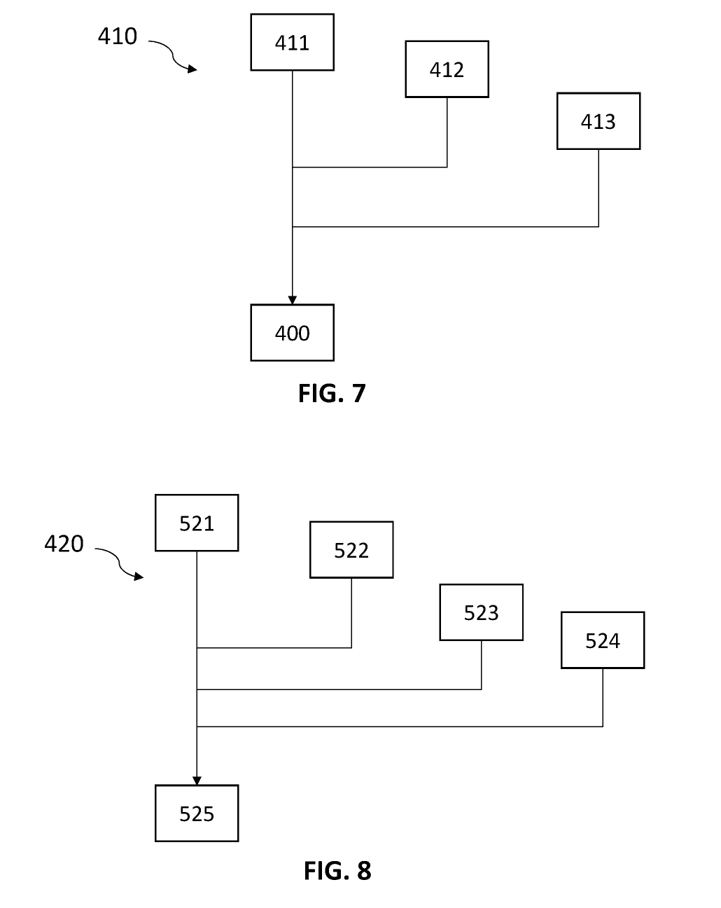

FIG. 7 illustrates a step for implementing a correction model of the determination of installations requiring maintenance action according to the invention,

FIG. 8 illustrates a step for updating a correction model of the determination of installations requiring maintenance action according to the invention.

### DESCRIPTION OF THE INVENTION

Throughout the description “geographic location” means a place which can be defined by its surface area, constituted by external zones and/or internal zones and comprise a plurality of installations requiring maintenance.

In terms of the invention “installation” means a building, a locale, a dwelling but also equipment (e.g. distributor of water, furniture).

In terms of the invention “maintenance” or “maintenance action” means an activity aimed at repairing, replenishing, cleaning or replacing an installation.

“Maintenance resources” means people, also called “maintenance technician” qualified to carry out maintenance actions or working with devices which can be necessary for executing maintenance actions.

The term “mass gathering” according to the invention corresponds to a planned or spontaneous event, preferably planned, which will attract a number of participants likely to considerably strain the resources of planning and action by administrators or of the host country. The Olympic Games, the Hajj and other major sporting, religious or cultural events are such examples.

According to the invention the term “distribution” refers to a number or to movement of people. The number can be expressed according to several dimensions as by density (e.g. people/m²), a total number (e.g. in hundreds of), a percentage (e.g. number of people/capacity of the zone). Movement corresponds to an entry and exit number of the geographic location or of a part of the geographic location. In this way, the “distribution datum” according to the invention corresponds to one or more values.

In terms of the invention “parameter” means a value obtained by transformation of raw data and which can be then used within a model. This applies especially to transformation of a series of images of a video or to transformation of a series of values obtained via a network sensor.

In terms of the invention “predetermined intervention threshold” means a predetermined value of distribution of participants or sensor measurement beyond which a maintenance action is prescribed.

In terms of the invention “model” or “rule” or “algorithm” is to comprise a finite suite of operations or instructions for calculating a value by means of a classification or partitioning of data within groups previously defined Y, and attributing a score or hierarchizing one or more data within a classification. Executing this finite suite of operations for example attributes a label Y to an observation described by a set of characteristics or parameters X for example by way of executing a function f likely to reproduce Y having observed X.

Y=f(X)+e

where e symbolizes noise or measurement error

In terms of the invention “ supervised learning method” means a process for defining a function f from a base of n labelled observations (X_{1 . . . n}, Y_{1 . . . n}) where Y=f (X)+e. “Non-supervised learning method” means a method aiming to hierarchize data or divide a set of data into different homogeneous groups, the homogeneous groups sharing common characteristics, and this without the observations being labelled.

In terms of the invention “process”, “calculate”, “determine”, “display”, “extract” “compare” or more widely “executable operation” means an action performed by a device or a processor, except if the context indicates otherwise. In this respect, operations relate to actions and/or processes of a data-processing system, for example a computer system or an electronic computer device, which manipulates and transforms the data represented as physical quantities (electronic) in the memories of the computer system or other storage, transmission or display of information devices. These operations can be based on applications or software.

The terms or expressions “application”, “software”, “program code”, and “executable code” signify any expression, code or notation, of a set of instructions intended to cause processing of data to perform a particular function directly or indirectly (e.g. after a conversion operation to another code). The examples of program code can include, without being limited, a sub-program, a function, an executable application, a source code, an object code, a library and/or any other sequence of instructions designed for execution on a computer system.

In terms of the invention “processor” means at least one hardware circuit configured to execute operations according to instructions contained in a code. The hardware circuit can be an integrated circuit. Examples of a processor comprise, without being limited, a central processing unit, a graphics processor, an integrated circuit specific to the application (ASIC) and a programmable logic circuit.

In terms of the invention “coupled” means connected directly or indirectly to one or more intermediate elements. Two elements can be coupled mechanically, electrically or be linked by a communications channel.

Throughout the description, the same references are used to designate the same elements.

The invention relates to a system or a process for maintenance management particularly useful in terms of maintenance management during mass gatherings. The events likely to assemble the most people are often pilgrimages, sporting events or cultural events. The present invention, though applicable to many mass gatherings, will be illustrated more particularly in a context of pilgrimage to Mecca, for example during the grand pilgrimage or of the small pilgrimage. In fact, the pilgrimage to Mecca represents some five million visitors each year to the towns of Mecca and Madinah in Saudi Arabia. These visitors meet up in particular during the annual ritual of the Hajj which is held over a precise number of days of the month of Dhul-Hijja of each lunar year, more particularly during the first twelve days. In 2017, the first day of the month of Dhul-Hijja of the lunar year 1437 was Aug. 23 2017.

The Hajj pilgrimage extends over a geographic location corresponding to Mecca or more than 1000 km². During this pilgrimage, participants at the Hajj, also called Hajjis, will pray five times per day in the same gathering places and will perform the same actions of worship as explained. They will have to walk seven times round the Kaaba for instance, make the walk between Safa and Marwa seven times, drink from the Well of Zamzam then go to the site of “Mina” 4 km from Mecca and say afternoon prayers (asr), evening prayers (maghreb and icha) and matins (fajr). They are also to travel to Mount Arafat where they say midday prayers and afternoon prayers, then go to “Muzdalifah” to say evening prayers. The next day, the pilgrim returns to Mina to carry out prescribed rites, or a trip of around 17 km (return trip). Also, pilgrims generally visit the mosque of the Prophet Mohamed (PSSL), Al-Masjid an-Nabawī, at Madinah. In this way, with several millions of pilgrims travelling across this territory over a very short period, administrations in charge of managing the gathering and more particularly checking participants are placed under high pressure. In fact, managing such an event represents an exceptional challenge especially as relates to the management of personal data of participants and particularly also in terms of prevention of fraud, the management of medical emergencies or more widely improvement of the experience lived by the pilgrim. Therefore, with several million pilgrims traversing this territory over a very short period and visiting several sites, administrations in charge of the maintenance management of sites are subjected to strong pressure with respect to hygiene and safety. Therefore, the Hajj pilgrimage brings together millions of pilgrims performing the same actions at the same time, producing a considerable density of pilgrims and all these actions are distributed over only a few days on an area of several square kilometers. Here, managing such an event represents an exceptional challenge especially as to the maintenance management of the relevant geographic location. The present invention can therefore be particularly useful in this context.

As presented in FIG. 1, according to a first aspect the invention relates to a maintenance management system 1 of a geographic location during a mass gathering which can preferably bring together at least several thousand people, preferably over 100,000 people, more preferably over a million people.

The geographic location corresponds to the site on which the mass gathering is held. Preferably, the geographic location is a site of large surface area requiring strict administration to respond to the demands of participants in terms of comfort. For example, the geographic location is a territory of over 100,000 m², preferably over 200,000 m ², more preferably over 500,000 m², even more preferably over 5 km². The geographic location in terms of the invention can be considered in its entirety but also can be divided into several parts or zones.

Also, the geographic location comprises a plurality of installations. The installations for example are selected from sites of worship, lavatories, housing, parks, but also from the equipment present inside these buildings or spaces such as for example benches, tables, dispensers (e.g. of water) and carpets. In terms of the Mecca pilgrimage, these installations are for example premises or structures such as the Kaaba, Safa, Marwa, the Well of Zamzam, the site of “Mina”, Muzdalifah”, the mosque of the Prophet Mohamed (PSSL), Al-Masjid Al-Nabawi, Medina or even equipment such as carpets or water dispensers. The geographic location comprises at least two installations whereof maintenance is to be managed, for example at least ten installations, preferably at least twenty installations, more preferably at least fifty installations, and even more preferably at least one hundred installations. Therefore, executing a dynamic maintenance management process in such a context is not comparable to conventional problems of household activities.

As presented in FIG. 1, the system 1 according to the invention comprises an analytical platform 100 or analytical computer platform. This analytical platform 100 is more particularly responsible for processing information, planning, generation of instructions and monitoring of the maintenance.

For this, this analytical platform 100 comprises an acquisition module 110 of distribution data of participants at said gathering, able to receive a distribution datum of participants at said gathering. As already mentioned, the distribution datum relates to the number (or volume) or movement of participants for the entire geographic location or for each part (e.g. zone) of the geographic location. Preferably, the distribution datum is obtained in real time or almost in real time. Therefore, the distribution datum corresponds for example to distribution of the population on the basis of raw data generated less than one hour prior to receipt of the distribution datum of participants at said gathering, preferably fewer than thirty raw data, preferably fewer than ten minutes and even more preferably fewer than five minutes.

The distribution datum of participants at said gathering can be obtained by any manual or automated means of counting people. Therefore, prior to its transmission to the analytical platform 100, the distribution datum can be generated by a counting device positioned at the entry of each of the installations, by image acquisition devices positioned inside the geographic location or again by network sensors able to acquire wireless communications data.

Preferably, the analytical platform 100 also comprises a calculation device 10 of a distribution datum of participants at said gathering, said device comprising:
a data acquisition module, able to acquire first distribution data of participants generated from data originating from the plurality of image acquisition devices and acquire first distribution data of participants generated from data originating from the plurality of network sensors, and
a data processing module able to calculate from first distribution data acquired, on the basis of a correction model by supervised or non-supervised learning, a distribution datum of participants at said gathering.

There is a high error rate in the estimation of the distribution of participants at a mass gathering when distribution is estimated with automated methods known from the prior art (camera, RFID . . . ). The device 10 obtains a distribution datum much closer to the real distribution values than the first distribution data acquired.

The analytical platform 100 also comprises a calculation module 120 of needs able to determine those installations requiring maintenance action. The maintenance actions are generally all the activities aimed at ensuring the well being and comfort of participants at a mass gathering and more particularly the Hajj pilgrimage. Preferably, maintenance actions are selected from cleaning actions (e.g. of equipment, grounds), replenishing consumables and replacement. Each installation can benefit from several different maintenance actions.

Determining installations requiring maintenance action is done especially as a function of the distribution datum of participants at said gathering obtained via the acquisition module 110. All the same, as will be presented in the suite, the calculation module 120 of needs is advantageously able to utilize complementary data to produce a more precise result on installations requiring maintenance action.

For this, the calculation module 120 of needs is especially configured to communicate with the distribution module 130 of resources, a maintenance resource management module 140, a repository 50, a recording module 150, a learning module 160, a viewing module 170 and a communications module 180.

The analytical platform 100 also comprises a distribution module 130 of resources, configured to set up associations between resources and installations requiring maintenance action.

For example, said associations can take the form of a data file stipulating which maintenance resource must occur on which installation. Preferably, said association also comprises the preferred operating time as well as its duration.

For this, the distribution module 130 of resources is especially configured to communicate with the calculation module 120 of needs, a maintenance management module 140 of resources, a repository 50, a recording module 150, a learning module 160, a viewing module 170 and a communications module 180.

As mentioned, the analytical platform 100 can comprise a maintenance resource management module 140 which is capable of communicating with the maintenance resources 30 and recording the availability data of maintenance resources. The maintenance resource management module 140 is advantageously able to update these data in real time.

Therefore, the maintenance resource management module 140 is advantageously configured to undertake monitoring in real time of the position and therefore the movements of maintenance resources. This can for example identify available maintenance resources for maintenance actions or underused maintenance resources.

Therefore, the maintenance resource management module 140 is advantageously configured to receive an item of information on the position of maintenance technicians. It can also be able to send an alert message to maintenance technicians, for example via the portable maintenance device 40 during a fresh maintenance action to be performed or during identification of a time period without movement.

The maintenance resource management module 140 can also be configured to identify a bottleneck of a part of the geographic location and generate an alert message. In fact, if the maintenance technicians or more broadly the maintenance resources are concentrated on a zone this risks creating a bottleneck.

Finally, the maintenance resource management module 140 is able to record some specific information on the maintenance resources such as their position, the skills of the maintenance technicians and the planning of actions for each of the maintenance resources.

Also, the analytical platform 100 can comprise a recording module 150 able to record the data received or generated by the platform. The recording module 150 can comprise a transitory memory and/or a non-transitory memory. The non-transitory memory can be a medium such as a CDrom, a memory card, or a hard drive for example hosted by a remote server. The recording module 150 is also able to manage a historical record of data received or generated by the analytical platform 100. Advantageously, the recording module 150 has architecture of LAMBDA, KAPPA or Architecture SMACK type.

Also, the analytical platform 100 can comprise a learning module 160 able to execute algorithms based on supervised or non-supervised learning methods. Therefore, the analytical platform 100 is advantageously configured to execute the input data in one or more algorithms, preferably previously calibrated. These algorithms are for example selected from a calculation algorithm of the distribution datum, a need calculation algorithm, and an algorithm for distribution of resources. Also, these algorithms can have different versions as a function of time of a period of the gathering. For example, in terms of pilgrimage, three periods can be considered: the Hajj or grand pilgrimage, the small pilgrimage and the rest of the year. This refines predictions originating from the models.

These algorithms can have been constructed from different learning models, especially partitioning, supervised or non-supervised. A non-supervised learning algorithm can for example be selected from a model of non-supervised Gaussian mix, a hierarchical clustering

Agglomerative, a hierarchical clustering divisive. Alternatively, the algorithm is based on a supervised statistical learning model configured so as to minimise risk of the sequencing rule and to obtain more effective prediction rules. In this case, the steps for calculating determination and estimations can be based on a model, resulting in a set of data and configured to predict a label. For example, for calibration purposes, it is possible to use a set of data representative of a situation whereof the label is known, for example the number of participants in a zone counted manually. The data set can also comprise multiple labels. The algorithm can come from use of a supervised statistical learning model selected for example from the kernel methods (e.g. Large-Margin Separators-Support Vector Machines SVM, Kernel Ridge Regression) described for example in Burges, 1998 (Data Mining and Knowledge Discovery. A Tutorial on Support Vector

Machines for Pattern Recognition), sets methods (e.g. decision trees) described for example in Brieman, 2001 (Machine Learning. Random Forests), FP-Growth, Apriori, hierarchical partitioning, k-medians partitioning, decision trees, logical regression or neurone networks described for example in Rosenblatt, 1958 (The perceptron: a probabilistic model for information storage and organization in the brain).

Also, the analytical platform 100 can comprise a supervision module 170 comprising a display device configured to display at least one item of information on the installations requiring maintenance action, the installations which are under maintenance, the installations which have been maintained and/or a list of available maintenance resources.

Also, the analytical platform 100 can comprise a communications module 180. By way of this communications module 180 the secure platform 100 is capable of communicating with a plurality of devices or systems involved in the management of personal data of a participant at the mass gathering. These devices or systems can for example be selected from: portable data readers, control checkpoints, vehicles. In this way, the communications module 180 is configured to receive and transmit information to remote systems such as sensors, tablets, telephones, computers or servers. The communications module 180 transmits the data over at least one communications network and can comprise wired or wireless communication. Preferably, the communication is operated by means of wireless protocol such as wifi, 3G, 4G, and/or Bluetooth. These data exchanges can take the form of sending and receiving files, preferably encrypted and associated with a specific receiver key. The communications module 180 is also able to allow communication between the platform 100 and a remote terminal, including a client. The client is generally any hardware and/or software likely to access the analytical platform 100.

The analytical platform 100 can advantageously comprise an analysis module 190 configured to generate analysed data selected from distribution of participants at said gathering as a function of time, maintenance needs as a function of time, distribution of maintenance resources as a function of time, consumption of resources, and the list of the most frequent maintenance actions or using most energy in terms of maintenance resources. These file are preferably generated from historical data. These files can then be processed by applications of representation so as to highlight pertinent information (format of “heat maps” type). Therefore, the analysis module 190 can generate statistical data for optimizing maintenance actions. It also reduces wastage of resources.

The different modules of the platform 100 are represented separately in FIG. 1 the invention can provide various types of arrangement such as for example a single module combining all the functions described here. Similarly, these means can be divided into several electronic cards, or else assembled onto a single electronic card. Also, when an action is ascribed to a device or a module, the latter is in fact performed by a microprocessor of the device or module controlled by instruction codes recorded in a memory. Similarly, if an action is ascribed to an application, the latter is in fact performed by a microprocessor of the device in a memory of which the instruction codes corresponding to the application are recorded. When a device or module sends or receives a message, this message is sent or received by a communication interface.

As presented in FIG. 1, the system according to the invention can comprise one or more sensors 20 positioned in the region of an installation and configured to measure the cleanliness of the installation and/or of the state of equipment in the installation. These sensors 20 can for example be selected from:
a backup device of the wear 21 of installations. Therefore, it is possible to automatically monitor wear on installations and for example wear on carpets in terms of the Mecca pilgrimage;
a backup device of the consumption 22 of consumables which scan for example be goblets and water jug coolers;
a backup device of cleanliness of installations 23. For example, dust sensors can be installed in mosques in Mecca for rapid alerting of the deposit of dust to a degree where intervention is necessary;
a backup device of incidents 24 giving notice via an external signal, generated manually or automatically, of an incident which will then be evaluated to determine whether sending a maintenance team is necessary;
a backup device of geographic position.

The system according to the invention is capable of communicating with a plurality of maintenance resources 30. In terms of the invention, the plurality of maintenance resources corresponds to at least two maintenance resources, for example at least ten maintenance resources, preferably at least twenty maintenance resources, more preferably at least fifty maintenance resources, and even more preferably at least one hundred maintenance resources. Therefore, executing a maintenance management process in such a context is not comparable to conventional problems of household activities. Also, even though the system does not cover maintenance resources 30, the system according to the invention can comprise one or more backup devices 31 of the position of each of the maintenance resources 30. These devices comprise for example RFID chips (for “Radio Frequency IDentification”), Bluetooth, GNSS (for “Global Navigation Satellite System”) and/or GSM (for “Global System for Mobile Communications”).

Advantageously, cleaners can have a portable maintenance management device 40 such as illustrated in FIG. 2. The portable maintenance management device 40 comprises a display module 41 allowing it for example to display instructions associated with maintenance actions, a processor 42 and a memory 43. It can also comprise a geolocation chip 44 of GNSS type (including GPS), an accelerometer 45, and a communication chip GSM 46 linked to a SIM card 47 preferably being fixed irremovably to the device (e.g. welded) and comprising a preferably encrypted memory 48.

As presented in FIG. 1, the system according to the invention can comprise a repository 50 which can be modified by third parties, preferably by authorised and authenticated third parties. This repository 50 can comprise different data 51, 52, 53, 54 which can be used by the computer platform 100 to manage maintenance. These data are for example relative to predetermined intervention thresholds for sensors 51, predetermined intervention thresholds for the distribution datum 52, data on the maintenance resources 53, data on the mass gathering 54 (e.g. duration, estimated number of people) or even data on the installations (e.g. average duration of intervention, frequency of intervention). The repository 50 can also be a remote server. It is for example possible to access this remote server via a web interface or directly via the appropriate functions directly implemented on a control device. All communications between the platform 100 and the remote server can be secured for example by HTTPS protocols and AES 512 encrypting.

Also, the system according to the invention can comprise one or more man-machine interfaces. The man-machine interface, in terms of the invention, corresponds to any element allowing a human being to communicate with a computer in particular and without this list being exhaustive, a keypad and means for responding to the orders input via the keypad to display data and by means of the mouse or of a trackpad optionally select elements displayed on the screen. Another embodiment is a touch screen for selecting directly on the screen the elements touched by finger or object and optionally with the possibility of displaying a virtual keypad.

According to another aspect, the invention relates to a maintenance management process 2 of a geographic location, comprising a plurality of installations, during a mass gathering. The steps of the process are illustrated in FIG. 3. The process according to the invention comprises in particular the following steps:
Recording 300, by an acquisition module 110 of distribution data, of a distribution datum of participants at said gathering,
Determination 400, by a calculation module 120 of needs, of installations requiring maintenance action as a function of the distribution datum of participants at said gathering, and
Setting up 500, by a distribution module 130 of resources, of associations between maintenance resources 30 and installations requiring maintenance action.

The recording 300 of a distribution datum of participants at said gathering can be based on data coming from devices external to the analytical platform 100 and this distribution datum can be generated by the analytical platform 100. In particular, this recording step 300 of a distribution datum of people can be preceded by a determination step 200 of a distribution datum of participants at said gathering.

FIG. 4 shows a determination step 200 of a distribution datum of participants at said gathering according to an embodiment. This determination is initiated by the acquisitions 201 and 202 of distribution data generated from data coming respectively from the plurality of image acquisition devices 10 and of the plurality of network sensors 20.

These data are then loaded into memory 210 and 220 by the calculation distribution module which also loads 230 into memory a learning model so it can execute a calculation step 240 allowing generation of distribution data which could then be recorded 250.

The determination 400 of installations requiring maintenance action as a function of the distribution datum of participants at said gathering is preferably done in real time.

The setting up 500 of associations between resources and installations requiring maintenance action is preferably done in real time.

FIG. 5 is a diagram illustrating exchanges between various elements of the system described above which can occur especially during the determination step 400 of installations requiring maintenance action as a function of the distribution datum of participants at said gathering.

FIG. 5 shows elements of the platform 100 such as the data acquisition module 110, the decision calculation module 120 and the distribution module 130 of resources as well as the recording module 150 and the learning module 160. This figure also shows elements external to the platform 100 such as the sensors 20 and the frames of reference 50.

During a first step 401, the module 120 receives from the module 110 a distribution datum of participants at said gathering. When the module 120 receives this distribution datum, verification is made during the step 402 for detecting the presence of sensors 20 linked to the installations. These sensors 20 are in particular configured to measure the state of the installation. If sensors are detected (OK), the data from sensors are received 403 by the module 120. During step 404, the module 120 can determine if predetermined intervention thresholds (relative to the distribution datum and/or the sensor data) are recorded in the repository 50 for the sensor values 20 considered. If this is the case (OK), these threshold values are considered 405 so as to interpret the values originating from the sensors. Therefore, if a sensor value 20 exceeds a predetermined intervention threshold then the calculation module 120 of needs could ascertain that the installation needs maintenance action. During this interrogation step 404 of the repository 50, the module 120 can also determine whether the repository comprises data on mass gathering such as for example data relative to future events which would need compliance of some installations before a certain date or again a ban on maintenance action on some time slots.

During step 406, the module 120 can interrogate the recording module 150 so as to obtain data relative to previous maintenance actions. This can for example be the date of the last maintenance action per installation. If such data are available (OK), then the data are acquired 407 by the module 120.

Therefore, even though determining installations requiring maintenance action can be done as a function of the distribution datum of participants at said gathering, the calculation module 120 of needs is advantageously able to use complementary data to produce a more exact result on installations requiring maintenance action. These complementary data can for example be:
data of sensors 20, the sensors preferably being configured to measure the state (e.g. the cleanliness) of the installation,
data relative to former maintenance actions (e.g. completion time of the last cleaning).

For this, the calculation module 120 of needs is capable of communicating with a recording module 150 for example to extract the former maintenance values.
data of predetermined intervention thresholds recorded in a repository 50. The data of the repository 50 can be modified via a man-machine interface.
data relative to the mass gathering, especially the number of people registered, recorded in a repository. For example, in terms of the Hajj pilgrimage the complementary data can correspond to the number of visas issued.

Following steps 403, 405, 407, corresponding to acquisition steps of complementary data which can be useful to determination of installations requiring maintenance action, the process comprises a step 408 corresponding to running an algorithm for determining installations requiring maintenance action by the module 120 in combination with the learning module 160. This step can also be conducted on the sole basis of the distribution datum of people if no complementary datum has been acquired (NOK).

As already presented, the decision calculation module 120 is capable of determining those installations requiring maintenance action, and this as a function of the distribution datum of participants. Also, it is advantageously able to:
generate a list comprising the state of each of the installations which could be displayed in a display device. The state can assume an alphanumeric value and appreciate the need to initiate maintenance action on each of the installations. For example, the state can correspond to a binary value: clean installation—dirty installation. All the same, the state can also be an encrypted value setting up for example an estimation of the state of wear of an installation;
determine a time slot when the installation will have exceeded a predetermined intervention threshold. This determination is advantageously made from the distribution data of people; and/or
record 409 the data of installations requiring maintenance action as a function of time. These data could then be used to improve predictions and recommendation formulated by the analytical platform 100 or again to make out reports.

Once determination is complete, during a step 410 the module 120 can send these data to the distribution module 130 of resources.

FIG. 6 is a diagram illustrating the exchanges between various elements of the system described hereinabove which can occur especially during the step 500 for setting up associations between maintenance resources and installations requiring maintenance action.

FIG. 6 shows elements of the platform 100 such as the decision calculation module 120, the distribution module 130 of resources and the management module 140 of resources, as well as the recording module 150, the learning module 160 and the communications module 180. This figure also shows elements external to the platform 100 such as the frames of reference 50.

In a first time, during a step 410 the module 130 receives from the module 120 data on the installations requiring maintenance action and, during a step 501, data on the maintenance resources from the management module 140 of resources.

The data on the maintenance resources received by the module 130 can be advantageously selected from:
An item of information in real time of the position of maintenance resources so as to identify available resources for maintenance actions as a function of their position; and/or
An item of information in real time on the skills of maintenance technicians and preferably the maintenance actions which have already been attributed to them that day, for example;
An item of information in real time of the immobility duration. The immobility can be considered here as being a shift of under 10 meters, preferably under 5 meters. This identifies available resources for maintenance actions as a function of their activity. In fact, immobility of over 1 minute, preferably over 5 minutes and more preferably over 10 minutes can be considered as inactivity,
An item of information in real time on a risk for the zone containing the maintenance resource to create a bottleneck. Therefore, if maintenance technicians observe this item of information on an electronic communication device they could act to prevent this bottleneck.

During step 502, the module 130 can interrogate the repository 50. If access to a repository 50 is confirmed during a step 502, during an interrogation step 502 of the repository 50, the module 130 can also determine whether the repository 50 comprises data on the mass gathering such as for example data relative to future events which would prevent the intervention of cleaners over some periods. If this is the case, these data are sent 503 to the module 130. The repository 50 can also comprise reference data on the maintenance needs of installations such as for example the conventional duration of maintenance actions for each of the installations or even the skills necessary for the different maintenance actions which could be considered 504 by the module 130. Advantageously, these data could be modified automatically as a function of data measured during the mass gathering by the learning module 160 or again manually via a man-machine interface. Such a supervised learning possibility improves the accuracy of production and optimizes use of maintenance resources.

During step 505, the module 130 can interrogate the recording module 150 so as to obtain data relative to current maintenance actions. This can for example be the date of the most recent maintenance action per installation. If such data are available (OK), the data are acquired 506 by the module 130.

Following steps 503, 504 and 506, corresponding to acquisition steps of complementary data which can be useful to the distribution of maintenance resources, the process comprises a step 507 corresponding to running an algorithm for distribution of maintenance resources by the module 130 in combination with the learning module 160. This step can also be conducted on the sole basis of maintenance resources data and installations requiring maintenance action if no complementary datum has been acquired (NOK).

As already presented, the maintenance distribution module 130 of resources is capable of setting up associations between maintenance resources and installations. Also, it is advantageously able to:
generate a verification list for each of the plurality of installations, the verification list comprising at least one state of the installation and/or of the equipment in the installation;
updating 508 of planning in the management resources module with estimated duration for the maintenance action to be carried out;
record 509 the resources distribution data as a function of time. These data could then be used to improve predictions and recommendation formulated by the analytical platform 100 or again for making out; and/or
notifying 510 maintenance technicians in response to determination of one or more installations requiring maintenance action. As presented in FIGS. 1 and 2, the platform 100 is capable of communicating with a portable maintenance device 40 comprising a display device 41, so that it displays at least one item of information on the installations requiring maintenance action and/or a path from the current position to an installation requiring maintenance action.

As has been mentioned, the process according to the invention can advantageously comprise a step 600 for running an algorithm originating from a supervised or non-supervised learning model such as for example an algorithm for distribution of resources or an algorithm for determination of needs. The latter can for example comprise attribution of a score to each of the installations as a function of data used during running of the algorithm. The score can for example be a score representative of a characteristic of the extent of wear, quantity, cleanliness. Running an algorithm for determination of needs can comprise classifying each of the installations into categories. For example, the process can associate each installation with a category such as “clean installation”, “dirty installation”, “installation to be cleaned within an hour”, “installation to be replenished”. FIG. 7 presents the execution 410 of such an algorithm for determination of needs by the learning module 160. As is shown, during a step 411 the learning module acquires the distribution datum at an instant t, then acquires 412 the sensor data at an instant t and finally loads 413 the algorithm for needs determination so as to determine 400 those installations requiring maintenance action.

Also, as shown in FIG. 8, the process according to the invention can advantageously comprise a step for updating resource distribution or needs determination algorithms. FIG. 8 presents execution 420 of updating of an algorithm for determination of needs by the learning module 160. As is shown, during a step 421 the learning module loads a plurality of distribution data corresponding to distribution data acquired during an earlier period, then loads 422 the sensor data acquired during this earlier period and advantageously it can also load alert data generated during this earlier period. Next and optionally it loads 423 the algorithm for determination of current needs. Finally, the learning module implements 424 a supervised or non-supervised learning model so as to most appropriately determine a new algorithm for needs determination.

The process according to the invention can also comprise a post-maintenance analysis step 700 of the performance of the maintenance action. Such a step, conducted for example by a performance control module, can verify, especially by way of the presence of sensors 20, if the maintenance action has been carried out effectively.

1. A dynamic management system of the maintenance of a geographic location during a mass gathering, said geographic location comprising a plurality of installations, said system being capable of communicating with a plurality of maintenance resources involved in the maintenance of the geographic location, said system comprising an analytical platform comprising:
an acquisition module of distribution data adapted to record a distribution datum of participants at said gathering,
a calculation module of needs adapted to determine the installations requiring maintenance action from the distribution datum,
a distribution module of resources configured to set up associations between the maintenance resources and the installations requiring maintenance action so as to manage the maintenance of the geographic location during said mass gathering, and
an analysis module configured to generate analysed data from said associations so as to allow dynamic maintenance management of the geographic location.

2. The system according to claim 1, wherein the acquisition module of distribution data is further adapted to calculate the distribution datum from first distribution data of participants generated from data from image acquisition devices and data from network sensors.

3. The system according to claim 1, further comprising one or more sensors selected from a backup device of consumption, a backup device of wear on installations, a backup device of cleanliness of installations, a backup device of geographic position and a backup device of incidents.

4. The system according to claim 1, wherein the calculation module of needs is configured to use complementary data to determine the installations requiring maintenance action, said complementary data being selected from:
measurement data of the a state of the installations generated by one or more sensors positioned in the installations and configured to measure the state of the installations,
data relative to former maintenance actions stored on a recording module,
data of predetermined intervention thresholds recorded in a repository, and/or
data relative to the mass gathering recorded in the repository.

5. The system according to claim 1, wherein the calculation module of needs is further configured to:
receive information on a state of the installations originating from one or more sensors positioned in each of one or more of said installations,
receive the distribution datum of participants at said gathering, and
determine the installations requiring maintenance action from information on the state of said installations and of the distribution datum of participants.

6. The system according to claim 1, wherein the calculation module of needs is further configured to generate a list comprising a state of each of the installations.

7. The system according to claim 1, wherein the analytical platform further comprises a management module of resources configured to generate an item of information, preferably in real time, on the distribution of maintenance resources.

8. The system according to claim 7, wherein the management module of resources is further configured to identify a period of prolonged inactivity of a maintenance resource.

9. The system according to claim 7, wherein the management module of resources is further configured to calculate, in real time, a surcharge rate for maintenance resources on a part of the geographic location, said management module of resources being configured to:
Receive a datum on the distribution of participants at said mass gathering on said part of the geographic location,
Receive a datum on the distribution of maintenance resources on said part of the geographic location,
Receive a datum on a reception capacity of said part of the geographic location, and
Calculate a surcharge rate for maintenance resources from distribution data of participants, distribution of maintenance resources and the reception capacity

10. The system according to claim 7, wherein the management module of resources is configured to:
Receive a datum relative to a risk of exceeding a capacity of a zone,
Receive a datum on the distribution of maintenance resources especially in said zone,
Send an alert message to personal devices of maintenance technicians present in said zone.

11. The system according to claim 1, wherein the analytical platform is adapted to communicate with a portable maintenance device comprising a display device, said portable device being configured so as to display at least one item of information on the installations requiring maintenance action and/or a path from a current position to one of said installations requiring maintenance action.

12. The system according to claim 1, wherein the analytical platform further comprises a recording module adapted to record the data received and/or generated by the platform and able to manage a historical record of said data.

13. The system according to claim 1, wherein the analytical platform further comprises a learning module adapted to execute a supervised or non-supervised learning model so as to generate predictive data selected from: predicted data on distribution of participants at said gathering, predicted data of the a state of said installations, predicted data of needs of maintenance actions, predicted data of position of maintenance resources and predicted data of consumption of resources.

14. The system according to claim 1, wherein the analysis module is configured to generate, from historical data, analysed data selected from the following analysed data: list of the most frequent maintenance actions or using the most energy in terms of maintenance resources, list of the installations using the most energy in terms of maintenance resources, real or predicted distribution of participants at said gathering as a function of time, real or predicted needs of maintenance actions as a function of time, real or predicted position of maintenance resources as a function of time, and real or predicted consumption of resources.

15. The system according to claim 1, characterized in that wherein the analytical platform further comprises a supervision module, comprising a display device allowing real-time supervision of maintenance resources, and configured to display at least one item of information on the installations requiring maintenance action, the installations which are under maintenance, the installations which have been maintained and/or a list of available maintenance resources.

16. A management process of the maintenance of a geographic location, comprising a plurality of installations, by a plurality of maintenance resources during a mass gathering, said process comprising the following steps:
recording, by an acquisition module of distribution data, of a distribution datum of participants at said gathering,
determination, by a calculation module of needs, of installations requiring maintenance action as a function of the distribution datum of participants at said gathering, and
setting up, by a distribution module of resources, of associations between maintenance resources and the installations requiring maintenance action.

17. The system according to claim 7, said management module of resources being configured to generate said item of information in real time.
